(19) United States
(12) Patent Application Publication
(10) Pub. No.: US 2002/0145589 A1
(43) Pub. Date: Oct. 10, 2002

(54) User interface for an e-marker

(75) Inventor: John Tree, London (GB)

Correspondence Address: Seong-Kun Oh, Sierra Patent Group, P.O. Box 6149, Stateline, NV, 89449, US

(73) Assignee: Sony Corporation of Japan

(21) Appl. No.: 09/827,504

(22) Filed: Apr. 6, 2001

(51) Int. Cl. G09G 5/00

(52) U.S. Cl. 345/156

(57) ABSTRACT

A desktop stand alone electronic data marker including a music marker is provided with a display unit and configured to display a user's electronic marks based on user input by illuminating a preassigned portion of the display unit.

### BACKGROUND OF THE INVENTION

1. Field of the Invention

The present invention relates to electronic devices. More particularly, the present invention relates to user interface electronic music markers.

2. Description of the Related Art

With increase in portable electronic devices such as personal digital assistants (PDAs) and WAP (Wireless Application Protocol) enabled mobile telephones, there has been a steady increase in these devices capable of performing more operations.

Sony Corporation and its U.S. subsidiary, Sony Electronics, Inc., introduced a so called e-marker which is capable of “bookmarking” a music clip while being played on a radio and is capable of recalling the information related to the bookmarked music clip such as the name of the song, the artist, the album containing the song and so on. Using the e-marker, a user can conveniently access the music clip information that the user listened to on the radio at a later time without the need to memorize the information or wait hopefully for the disc jockey on the radio to provide that information. In this manner, if the user wants to, for example, purchase the music album which the user has marked using the e-marker, the user can easily identify the necessary information related to the marked music clip from the e-marks provided by the e-marker.

While the e-marker has been introduced as a portable electronic device which can easily fit into a user's hand or slip into a key chain ring or a shirt pocket, there are times when a user listens to the radio or other types of broadcast at, for example, the user's desk at the office or placed on a bookshelf, at home. In such cases, it may be desirable to have a stand alone type of communication device which is capable of performing the functions of an e-marker without necessarily being configured for portability. Indeed, it may be desirable to have a communication device which a user can find a permanent place near other electronic devices which are capable of outputting broadcast signals such as radios, televisions, and media files outputted by a personal computer.

### SUMMARY OF THE INVENTION

In one embodiment, a stand-alone type electronic music marker device is provided which is configured to perform the functions of an e-marker device and is designed with visually attractive housing using metallic frame and the like to be placed permanently in an office or a home. In particular, an electronic data marker device in one embodiment includes a display unit including a plurality of display panels positioned on the display unit, and an input unit for inputting data marks into the display unit, the display unit configured to display the data marks received from the input unit and correspondingly display the received data marks on the plurality of display panels. In another embodiment, there is provided a method including receiving a data mark and displaying the data mark. In yet another embodiment, there is provided a method including detecting a connection to a gateway device, transmitting stored data marks to the gateway device, receiving data corresponding to the data marks and displaying the received data.

These and other features and advantages of the present invention will be understood upon consideration of the following detailed description of the invention and the accompanying drawings.

### BRIEF DESCRIPTION OF THE DRAWINGS

FIG. 1 illustrates one embodiment of a front view of an electronic music marker;

FIG. 2 illustrates a back view of the music marker of FIG. 1;

FIG. 3 illustrates a side view of the music marker of FIG. 1;

FIG. 4 illustrates a top view of the music marker of FIG. 1;

FIG. 5 illustrates a bottom view of the music marker of FIG. 1;

FIG. 6 illustrates another embodiment of a front view of an electronic music marker;

FIG. 7 illustrates a back view of the music marker of FIG. 6;

FIGS. 8A and 8B illustrate left and right side views of the music marker of FIG. 6;

FIG. 9 illustrates a top view of the music marker of FIG. 6;

FIG. 10 illustrates a bottom view of the music marker of FIG. 6;

FIG. 11 is a flow chart for illustrating one embodiment of the electronic music marker operation; and

FIG. 12 is a flow chart for illustrating one embodiment of downloading data from the user's e-marker account to the electronic music marker.

### DETAILED DESCRIPTION

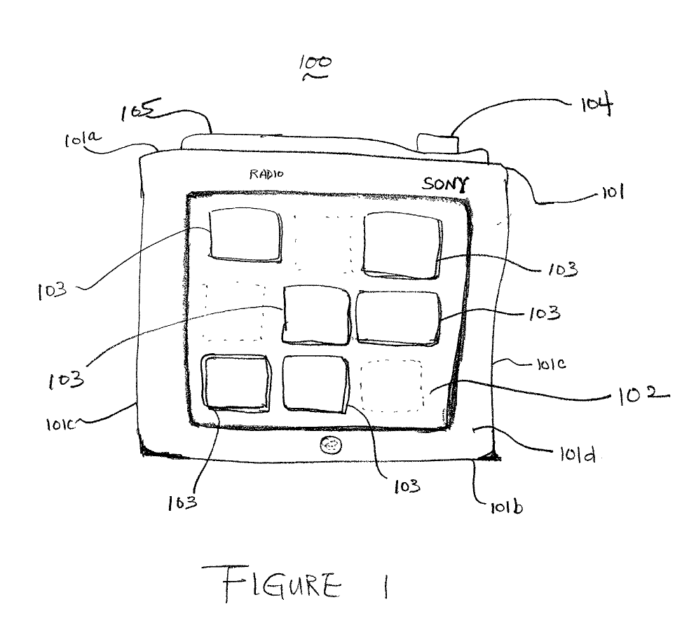

FIG. 1 illustrates one embodiment of a front view of an electronic music marker 100. Referring to FIG. 1, electronic music marker 100 includes housing 101 which encases stand-alone electronic music marker 100. Housing 101 includes front panel 102 and a plurality of e-mark display panels 103 located within front panel 102. Each e-mark display panel 103 is individually capable of being illuminated and further, may provide, in one embodiment, text display and image display capability responsive to the user's input commands. Housing 101 includes upper surface 101a, lower surface 101b, a pair of side surfaces 101c, front surface 101d, and back surface 101e (not shown) to substantially encase the stand-alone electronic music marker 100.

Electronic music marker 100 further includes first e-button 104 which operates in substantially the same manner as the e-button provided on a commercially available e-marker device. Furthermore, second e-button 105 operates in a substantially similar manner as double clicking the e-button on the e-marker device for marking a registered television channel. In an alternate embodiment, first e-button 104 and second e-button 105 may be combined together into a single e-button. In one embodiment, first and second e-buttons 104, 105 are mounted on top surface 101a of housing 101 with a conventional spring-loaded mechanism to permit user input operations.

As shown, each e-mark display panel 103 may be configured with separate liquid crystal displays (LCDs) to enable displaying text and image information corresponding to the user's input commands. As mentioned above, each e-mark display panels are individually controlled and manipulated based on the user's input commands via first second e-buttons 104, 105, respectively, such that when the user depresses either of first second e-buttons 104, 105, respectively, one of the e-mark display panels is illuminated. As will be discussed in further detail below, when stand-alone electronic music marker 100 is connected to a personal computer via a USB port, for example, to connect to the user's e-marker account at the e-marker web site, upon verification of the user's identity corresponding to the e-marker account that the user is attempting to access, information corresponding to the e-marked songs are displayed in respective e-mark display panels 103. In an alternate embodiment, stand-alone electronic music marker 100 may be connected to a personal computer via a serial port or a parallel port for cable connection, or via an infra red (IR) port for wireless connection, or any other compatible interface type such as IEEE-1394 and RS-322C interface protocols.

In one embodiment, when a user hears a radio or television broadcast of a music piece and wishes to mark that particular music piece so that the user may retrieve information related to that particular music piece at a later point in time or purchase that music piece, the user operates first or second e-buttons 104, 105, respectively. Then, a corresponding e-mark display panel 103 is illuminated indicating that the user has e-marked a particular music piece. In one embodiment, the e-mark display panel 103 may also display time and date information of when the user operated first or second e-buttons 104, 105, respectively, in addition to being illuminated.

In this manner, the user may continue to e-mark music pieces that are broadcast from registered radio or television stations, and with each user's operation of first or second e-buttons 104, 105 respectively, to e-mark particular music pieces, a corresponding e-mark display panel 103 is illuminated. In one embodiment, the pattern of illuminated e-mark display panels 103 may be predetermined and configured by the user such that a certain sequence of e-mark display panels 103 are illuminated responsive to the user's operation of first or second e-buttons 104, 105, respectively. For example, with each operation of either of first and second e-buttons 104, 105, electronic music marker 100 may be configured to illuminate e-mark display panels 103 in a diagonal manner such that the user's first operation of on of first and second e-buttons 104, 105 illuminates the top left corner e-mark display panel 103. Thereafter, the user's subsequent operation of one of first and second e-buttons 104, 105 illuminates e-mark display panel 103 positioned at the center of front panel 102, followed by illumination of e-mark display panel 103 located at the bottom right corner of front panel 102 responsive to the user's subsequent operation of either of first and second e-buttons 104, 105, respectively.

Alternatively, the sequence of illuminating each e-mark display panels 103 responsive to the user's operation of first and second e-buttons 104, 105, respectively, may be randomly assigned. Moreover, in one embodiment, when the user is not using electronic music marker 100, e-mark display panels 103 may be configured to illuminate a predetermined pattern or a sequence of predetermined patterns for display. In particular, electronic music marker 100 may be configured to display a predetermined sequence of alphabet or numbers (or in a random manner) by illuminating certain e-mark display panels 103 for a predetermined time period. For example, to display the letter “H”, electronic music marker 100 can be configured to illuminate e-mark display panels 103 positioned on the left and right columns on front panel 102 and the center e-mark display panel 103.

When the user connects electronic music marker 100 to a gateway device such as a personal computer and the like, and logs onto the user's account at e-marker.com web site, the information corresponding to the e-marked music pieces are automatically transferred to the user's e-marker account. Moreover, in one embodiment, electronic music marker 100 may be configured to receive information corresponding to each e-marked music piece from the e-marker.com web site such that each e-mark display panel 103 may be configured to display information corresponding to the particular music piece that the user e-marked. For example, electronic music marker 100 may receive information corresponding to the music piece such as the name of the music piece, the name of the artist, the name of the album for the music piece, and so on. Additionally, electronic music marker 100 may also receive image data (for example, in the form of .jpg, .gif and other compatible image file formats) corresponding to the music piece such as a still image of the album cover for the music piece, a still image of the artist for the music piece for display on the respective e-mark display panels 103. Alternatively, electronic music marker 100 may be configured to receive a short video clip, an animated music video clip corresponding to the e-marked music piece, or a video clip of the artist for the e-marked music piece (for example, in formats such as .mpg, .avi, and so on) for display on the corresponding e-mark display panels 103. In one embodiment, the image data may be concurrently displayed on e-mark display panel 103 with the text data. Alternatively, only video data or text data may be displayed on a particular e-mark display panel 103.

Additional detailed information relating to the operation of the electronic music marker 100 can be found in pending application Ser. No. 09/126,007 filed on Jul. 29, 1998 and application Ser. No. 09/401,103 filed on Sep. 22, 1999, both assigned to Sony Corporation, joint-assignee of the present application with Sony Electronics, Inc., a subsidiary of Sony Corporation, the disclosures of each of which are herein incorporated in their entirely by reference for all purposes.

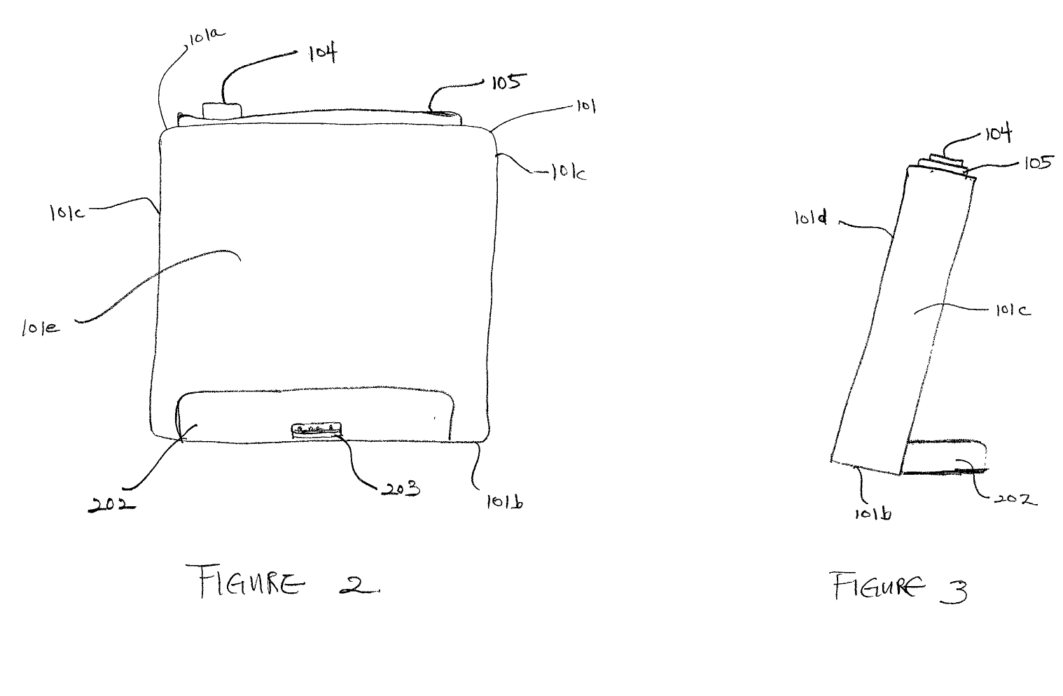

FIG. 2 illustrates a back view of electronic music marker 100 of FIG. 1. Referring to FIG. 2, housing 101 is provided with back surface 101e to substantially encase electronic music marker 100 along with front, side, top and bottom surfaces, 101d, 101c, 101a, and 101b, respectively. Further shown in FIG. 2 is base 202 which is connected to back surface 101e of housing 101 substantially at the bottom to provide physical support of stand-alone electronic music marker 100 when placed on a surface such as a desk, a bookshelf, and the like. Additionally, FIG. 2 further shows a Universal Serial Bus (USB) port 203 which, in one embodiment, allows the stand-alone electronic music marker to be connected to a personal computer to access the user's e-marker account via a typical internet connection.

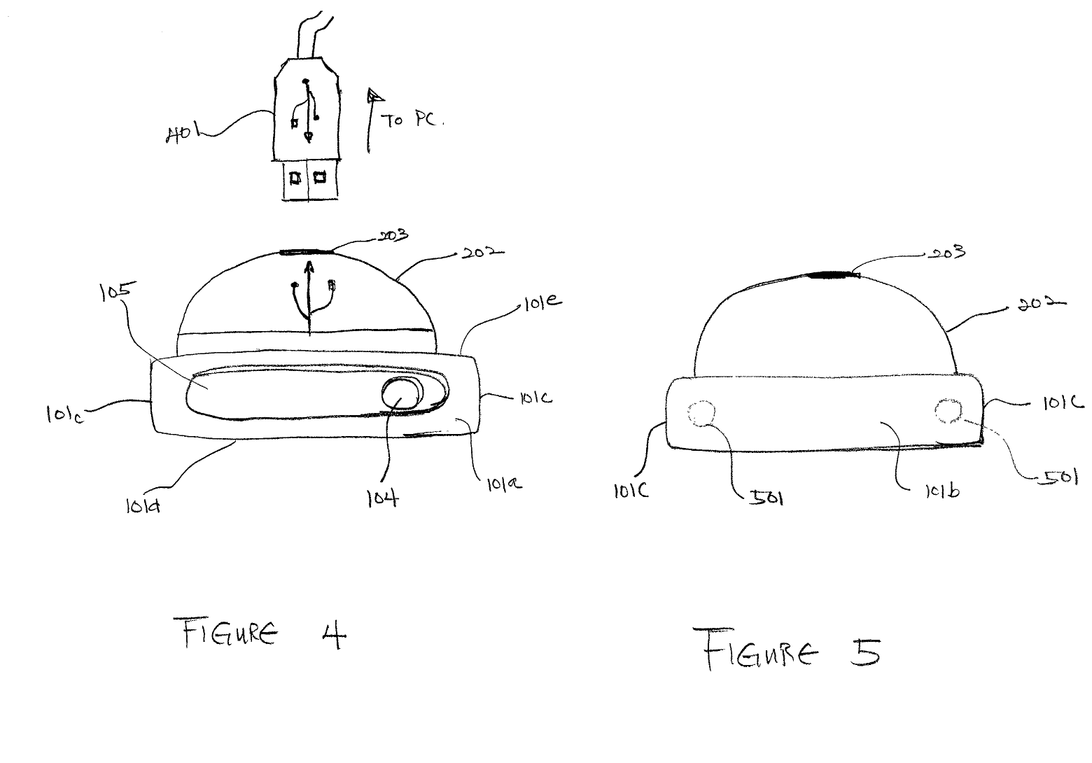

FIG. 3 illustrates a side view of electronic music marker 100. In one embodiment, left and right side surfaces 101c are substantially the same, and thus only one illustration is provided. FIGS. 4 and 5 illustrate a top view and a bottom view respectively of the electronic music marker 100.

Referring to FIG. 4, USB port 203 may be configured to receive USB cable connection 401 to be linked with a personal computer or other peripheral and the like. Furthermore, referring to FIG. 5, base surface 101b of electronic music marker 100 may be provided with a pair of slip resistant pads 501 which are configured to prevent housing 100 from easily sliding on a surface. Slip resistant pads 501 may be, for example, felt pads or rubber pads that are configured to provide additional support to base surface 101b of housing 100 in addition to base 202. Additionally, while base 202 shown in FIGS. 4 and 5 are shaped in a substantially semi-circle shape, in alternate embodiments, base 202 can be configured in other shapes such as a rectangular shape, a triangular shape, and so on.

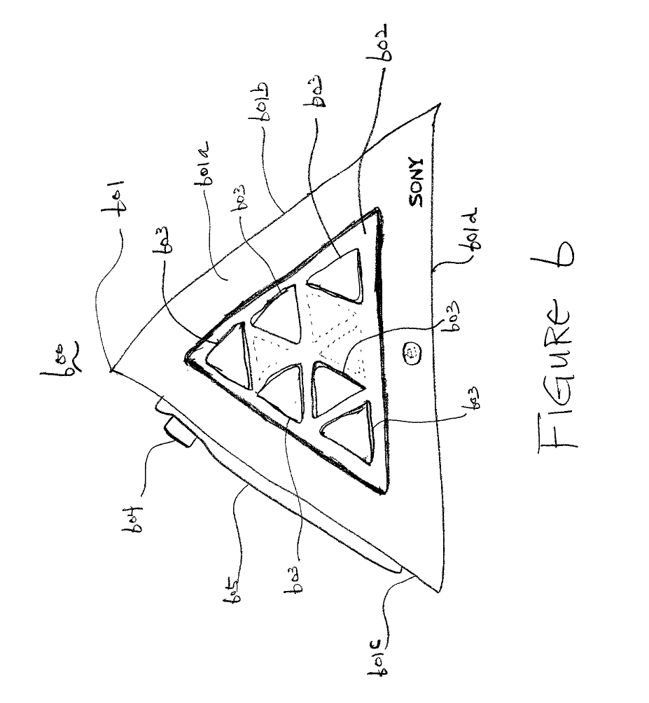

FIG. 6 illustrates an alternate embodiment of a front view of electronic music marker 600. The embodiment shown in FIG. 6 is substantially triangular shaped as compared with the substantially rectangular shaped embodiment illustrated in FIGS. 1-5. The operation of the respective buttons and panels are substantially the same as that shown in FIGS. 1-5.

Referring to FIG. 6, electronic music marker 600 includes housing 601 which includes front surface 601a, back surface 601e (not shown), right surface 601b, left surface 601c,and bottom surface 601d. Housing 601 is substantially in a triangular shape as is front panel 602 on front surface 601a of housing 601. Within front panel 602 are provided a plurality of e-mark display panels 603, each of which, similar to e-mark display panels 103 shown in FIG. 1, is configured to illuminate and display text and image information corresponding to the user input commands.

In one embodiment, e-mark display panels 603 are arranged to substantially maximize the area of front panel 602, and accordingly, as shown, arranged side by side within front panel 602. However, these e-mark display panels 103 may be positioned within front panel 602 of housing 601 in other manner as desired such as aligning e-mark display panels 602 along the inner periphery of front panel 602 and so on. Alternatively, e-mark display panels 602 may be configured in a predetermined pattern by the user.

Referring again to FIG. 6, first and second e-buttons 604, 605, respectively, are provided on left surface 601c of housing 601. Alternatively, first and second e-buttons 604, 605, respectively, may be provided on right surface 601b of housing 601. First and second e-buttons 604, 605, respectively, are configured to operate in a similar manner as first and second e-buttons 104, 105, respectively, of FIG. 1, for respectively marking songs broadcast on registered radio station and registered television channel.

FIG. 7 illustrates a back view of the electronic music marker 600. Referring to FIG. 7, similar to the embodiment shown in FIGS. 4-5, in the embodiment shown in FIG. 7, there is provided base 702 connected to housing 601 substantially at the bottom of housing 601 to provide support thereto. Additionally, USB port 703 on base 702 may be provided for connecting electronic music marker 600 to the user's e-marker account via a USB connector (not shown) connected to a personal computer and the like which has access to the internet.

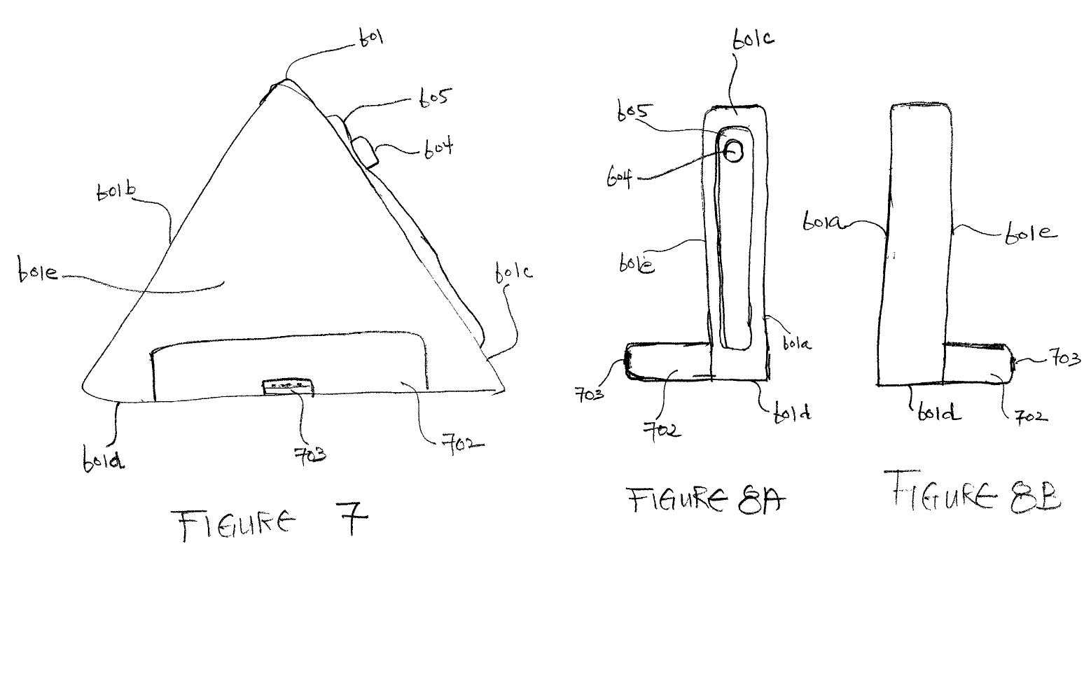

FIGS. 8A and 8B illustrate left and right side views, respectively of the electronic music marker 600. FIG. 9 illustrates a top view electronic music marker 600. Referring to FIG. 9, USB connector 901 connected to a personal computer can be provided for connection to USB port 703 of the electronic music marker 600 to access the user's e-marker account via the personal computer.

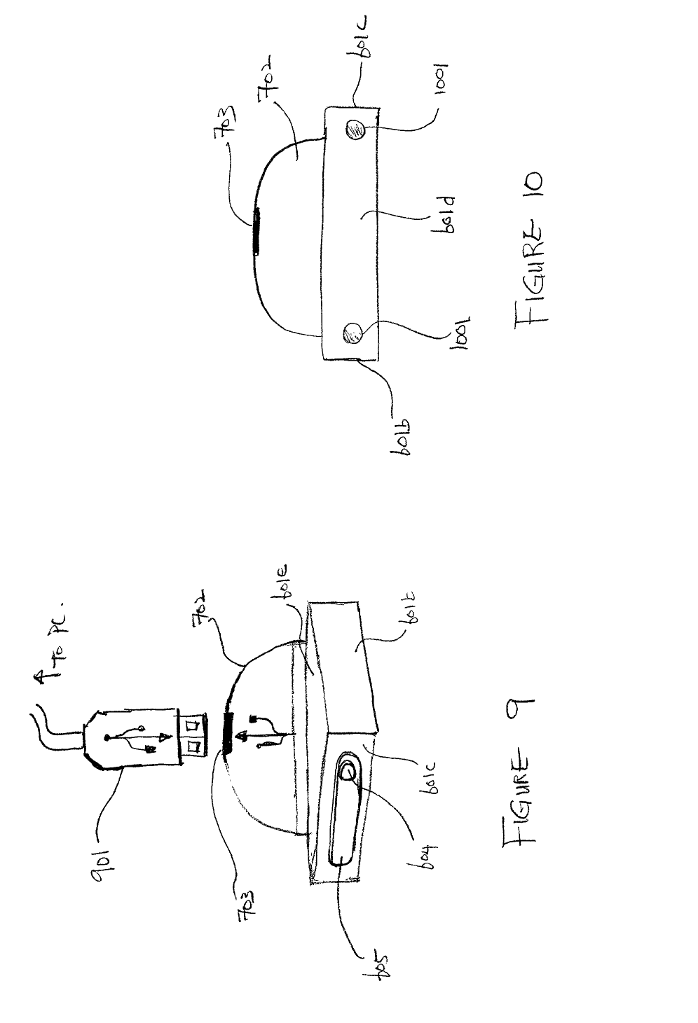

FIG. 10 illustrates a bottom view of the electronic music marker 600. Similar to the embodiment shown in FIG. 5, base surface 601d of electronic music marker 600 is provided with a pair of slip resistant pads 1001 which are configured to prevent housing 600 from easily sliding on a surface. Again, slip resistant pads 1001 can be, for example, felt pads or rubber pads that are configured to provide additional support to base surface 601d of housing 600 in addition to base 702. Additionally, while base 702 shown in FIGS. 9 and 10 are shaped in a substantially semi-circle shape, in alternate embodiments, base 702 can be configured in other shapes such as a rectangular shape, a triangular shape, and so on.

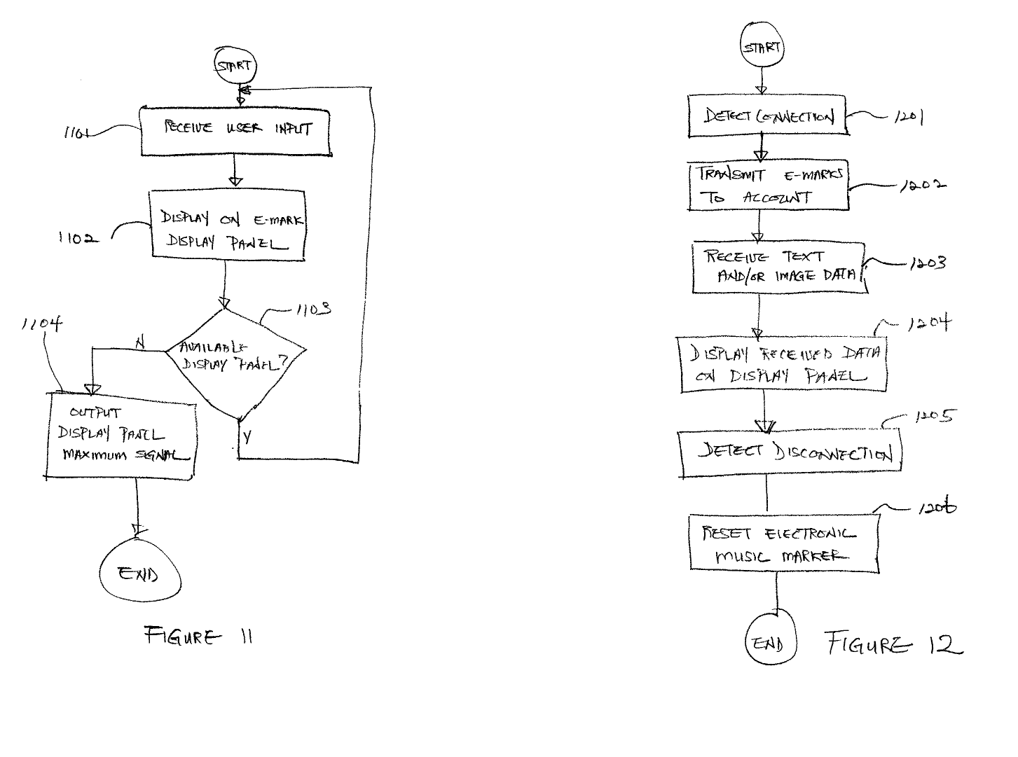

FIG. 11 is a flow chart for illustrating one embodiment of the electronic music marker operation. Referring to FIG. 11, at step 1101, electronic music marker 100 detects user's input operation of one of first and second e-buttons 104, 105, respectively. Then, at step 1102, electronic music marker 100 illuminates a corresponding e-mark display panel 103. As discussed above, in one embodiment, the corresponding e-mark display panel 103 may also display time and/or date information of the user's input operation of first or second e-buttons 104, 105, respectively.

At step 1103, electronic music marker 100 determines whether all available e-mark display panels 103 are being used (i.e., illuminated in response to user's input operation of first or second e-buttons 104, 105, respectively.). If it is determined that there are e-mark display panels 103 available, electronic music marker 100 waits for further input operation by the user at step 1101. On the other hand, if it is determined at step 1103 that all available e-mark display panels 103 are in use, then at step 1104, electronic music marker 100 generates an output signal to inform the user that electronic music marker 100 has reached its maximum number of e-marks that it can handle, and the procedure ends. In one embodiment, the output signal from electronic music marker 100 to inform the user that it has reached its maximum number of e-marks it can handle may be an audible signal such as an audible tone via an audio output terminal (not shown). Alternatively, electronic music marker 100 may be configured to flash all e-mark display panels 103 simultaneously for a predetermined period of time to visually indicate to the user that it has reached its maximum number of e-marks that it can handle.

FIG. 12 is a flow chart for illustrating one embodiment of downloading data from the user's e-marker account to the electronic music marker. Referring to FIG. 12, at step 1201, electronic music marker 100 detects a connection to a gateway device such as a personal computer connected to the internet. After the user enters the user's account information and performing necessary e-marker account access steps at the gateway device, at step 1202, data corresponding to the e-marks stored in electronic music marker 100 is transmitted to the user's e-marker account via the gateway device, and in response, the corresponding text and/or image (including video) data are retrieved from a server terminal of e-marker.com's web site and transmitted to the user's e-marker account. Then, at step 1203, the text and/or image data corresponding to each e-marks are downloaded onto electronic music marker 100. At step 1204, the downloaded text and/or image data are displayed on each corresponding e-mark display panel 103 on electronic music marker 100.

When the user disconnects electronic music marker 100 from the gateway device, the termination of the connection between electronic music marker 100 and the gateway device is detected at step 1205. Then, at step 1206, electronic music marker 100 is reset such that previously stored e-marks inputted by the user may be erased from electronic music marker 100, and correspondingly, the illuminated e-mark display panels 103 are turned off. The user may then operate first and second e-buttons 104, 105, respectively, again, to input additional e-marks of music broadcasts from registered radio and television broadcast stations.

As discussed above, in one embodiment, a stand-alone type electronic music marker device is provided which is configured to perform the functions of an e-marker device and is designed with visually attractive housing using metallic frame and the like to be placed permanently in an office or a home. In particular, an electronic data marker device in one embodiment includes a display unit including a plurality of display panels positioned on the display unit, and an input unit for inputting data marks into the display unit, the display unit configured to display the data marks received from the input unit and correspondingly display the received data marks on the plurality of display panels.

Furthermore, in one embodiment, the display unit may include one of a liquid crystal display, a cathode ray tube display, and a touchpad display unit. Moreover, the housing may be mounted to a base for vertically supporting housing, with the display unit is mounted substantially on the front surface of the housing. Additionally, the display panels on the display unit are provided in a substantially non-overlapping manner with each of the display panels having substantially the same dimensions, for example, in the shape of a square, a triangle or a rectangle, arranged in a uniform array. Of course, within the scope of the present invention, the display panels may be designed each with a unique dimension.

Moreover, in one embodiment, the display unit may be configured to selectively display an indication of the received data marks on a corresponding display panel, examples of such indication including an image corresponding to the data mark, a text corresponding to the data mark, or a combination of the image and text. Also, the indication on the display panels may be displayed in conjunction with the respective display panels being illuminated.

The input unit of the electronic music marker device may include a music broadcast mark button and a television broadcast mark button for marking music broadcast from a registered radio station and a registered television station. Further, in one embodiment, the base can be provided with an output unit or terminal for connecting to an external device such as a personal computer, a personal digital assistant, a WAP-enabled mobile telephone, a mobile telephone configured to operate under the so-called i-mode for wireless internet connection, or a television set enabled for web-TV internet access. The output terminal can include one or more of a USB port, a serial port, a parallel port, and an infra red (IR) port.

Additionally, the display panels on the electronic music marker can be configured to display, upon synchronization with user's e-marker account via an internet connection, one or more of a title of the music and the artist corresponding artist, a title of the album for the marked music and a graphical display of the music album and the artist each corresponding to the music mark inputted by the user.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. An electronic data marker device, comprising:
a display unit including a plurality of display panels positioned on said display unit; and
an input unit for inputting data marks, said display unit is configured to receive said data marks from said input unit and correspondingly display said data marks on said plurality of display panels.

2. The device of claim 1 wherein said display unit includes one of a liquid crystal display, a cathode ray tube display, and a touchpad display unit.

3. The device of claim 1 further including a base mounted to said display unit for vertically supporting said display unit.

4. The device of claim 1 wherein each of said plurality of display panels on said display unit are non-overlapping.

5. The device of claim 1 wherein each of said plurality of panels have substantially the same dimensions.

6. The device of claim 5 wherein said plurality of display panels are arranged on said display unit in a substantially uniform array.

7. The device of claim 5 wherein each of said plurality of display panels are of one of a square shape, a triangular shape, and a rectangular shape.

8. The device of claim 1 wherein said display unit is configured to selectively display an indication of said received data marks on a corresponding one or more of said plurality of display panels.

9. The device of claim 8 wherein said display unit displays said indication of received data marks by illuminating said corresponding one or more of said plurality of display panels.

10. The device of claim 1 wherein said data marks include information corresponding to a music file.

11. The device of claim 10 wherein said information corresponding to said music file includes a text and an image information corresponding to said music file.

12. The device of claim 1 wherein said input unit includes a spring loaded button.

13. The device of claim 1 wherein said input unit includes a music broadcast mark button and a television broadcast mark button.

14. The device of claim 1 further including an output unit for coupling to an external device.

15. The device of claim 14 wherein said output unit includes one or more of a USB port, a serial port, a parallel port, and an infra red (IR) port.

16. The device of claim 14 wherein said external device includes one or more of a personal computer, a personal digital assistant, a television set, a mobile telephone, a pager, and a wireless communication device.

17. The device of claim 14 wherein said external device is configured to correspondingly display said received data marks on said external device.

18. The device of claim 17 wherein said data marks are music marks corresponding to music files and further, wherein said data marks displayed on said external device includes information corresponding to said each received music marks.

19. The device of claim 18 wherein said music marks displayed by said external device includes one or more of a title of the music corresponding to said each music marks, a name of the artist corresponding to each music marks, a title of the album corresponding to each music marks, and a graphical display of an album cover corresponding to each music marks.

20. A method, comprising:
receiving a data mark; and
displaying the data mark.

21. The method of claim 20 further including:
determining that maximum number of data marks have been received; and
outputting an output signal responsive to said determining step.

22. The method of claim 21 wherein said output signal includes one of an audio signal and a display signal.

23. The method of claim 21 wherein said maximum number is nine.

24. The method of claim 20 wherein said step if displaying said data mark includes the step of illuminating a display panel corresponding to the receiving step.

25. The method of claim 20 wherein said data marks include one or more of a time stamp information and a date stamp information.

26. A method, comprising:
detecting a connection to a gateway device;
transmitting stored data marks to said gateway device;
receiving data corresponding to said data marks; and
displaying said received data.

27. The method of claim 26 further including:
detecting a disconnection from said gateway device; and
resetting said stored data marks.

28. The method of claim 27 wherein the resetting step includes deleting the stored data marks.

29. The method of claim 26 wherein said connection includes one of a parallel, serial or USB cable connection, a wireless connection.

30. The method of claim 26 wherein said gateway device includes one of a personal computer and a server terminal.

31. The method of claim 26 wherein said received data includes one or more of text data, still image data, animated image data, and video data corresponding to the stored data marks.

32. An electronic data marker device, comprising:
input means for inputting a plurality of data marks; and
display means for displaying a plurality of data marks, said display means configured to display said data marks received from said input on corresponding display panels.
